(19) United States
(12) Patent Application Publication
(10) Pub. No.: US 2022/0063186 A1
(43) Pub. Date: Mar. 3, 2022

(54) ADDITIVELY MANUFACTURING FLUORINE-CONTAINING POLYMERS

(71) Applicant: Honeywell Federal Manufacturing & Technologies, LLC, Kansas City, MO (US)

(72) Inventor: Thomas Matthew Selter, Blue Springs, MO (US)

(73) Assignee: Honeywell Federal Manufacturing & Technologies, LLC, Kansas City, MO (US)

(21) Appl. No.: 17/500,191

(22) Filed: Oct. 13, 2021

Related U.S. Application Data
(62) Division of application No. 16/798,561, filed on Feb. 24, 2020.

(51) Int. Cl. B29C 64/153; B33Y 10/00; B33Y 70/10; B33Y 30/00

(52) U.S. Cl. CPC B29C 64/153; B33Y 30/00; B33Y 70/10; B33Y 10/00

(57) ABSTRACT

A system and method of additively manufacturing a part including fluorine-containing polymers and an additive. The additive may include stainless steel, bronze, molybdenum disulfide, polyimide, or any other suitable additive. The method includes depositing fluorine-containing polymer additive manufacturing material onto a build platform, selectively cross-linking portions of the deposited additive manufacturing material, and curing the selectively cross-linked portions such that at least one characteristic of the part is improved via the additive.

### RELATED APPLICATIONS

The present patent application is a divisional patent application claiming priority benefit, with regard to all common subject matter, to U.S. patent application Ser. No. 16/798,561, entitled “ADDITIVELY MANUFACTURING FLUORINE-CONTAINING POLYMERS”, filed Feb. 24, 2020. The earlier-filed patent application is hereby incorporated by reference in its entirety into the present application.

### STATEMENT REGARDING FEDERALLY-SPONSORED RESEARCH OR DEVELOPMENT

This invention was made with Government support under Contract No.: DE-NA-0002839 awarded by the United States Department of Energy/National Nuclear Security Administration. The Government has certain rights in the invention.

### BACKGROUND

Additive manufacturing with fluorine-containing polymers is currently limited by several factors. For example, fluorine-containing polymer parts do not have sufficient strength, rigidity, wear resistance, or compression for certain applications. Fluorine-containing polymer parts also have undesirable surface friction or suffer from creep or cold flow. Fluorine-containing polymer parts are also not ideal for dry running or stop-start applications. Furthermore, general limitations of conventional manufacturing techniques such as material removal tooling restrictions prevent fluorine-containing polymers from being used in many parts.

### SUMMARY OF THE INVENTION

Embodiments of the present invention solve the above-mentioned problems and other problems and provide a distinct advance in the art of manufacturing parts including fluorine-containing polymers. More particularly, the present invention provides an improved system and method for additively manufacturing parts including fluorine-containing polymers and at least one additive so as to eliminate the limitations described above.

One embodiment of the invention is an additive manufacturing system comprising a build platform, a material deposition device, an energy source, and a cure device. The additive manufacturing system utilizes an additive manufacturing material including fluorine-containing polymers and an additive to form a part having improved characteristics. The additive manufacturing system may employ any additive manufacturing or “3D printing” methods such as sintering, laser melting, laser sintering, DIW, extrusion, fused filament, stereolithography, light polymerizing, powder bed, wire additive, or laminated object manufacturing. The additive manufacturing system may also be a hybrid system that combines additive manufacturing with molding, scaffolding, and/or other subtractive manufacturing or assembly techniques.

The additive manufacturing material may be in pellet or powder form or any other suitable form. The additive may be stainless steel, bronze, molybdenum disulfide, polyimide, or any other suitable additive. An additional material such as calcium fluoride or glass may further be added.

The build platform may be a stationary or movable flat tray or bed, a substrate, a print plate, a shaped mandrel, a wheel, scaffolding, or similar support. The build platform may be integral with the additive manufacturing system or may be removable and transferable with the part as the part is being constructed.

The material deposition device may include a nozzle, guide, sprayer, or other similar component. The material deposition device may be configured to deposit material via direct ink writing (DIW) at room temperature for subsequent curing. In one embodiment, the material mixture deposition device is configured to create a lattice structure.

The energy source may be a laser, heater, or similar component for melting the additive manufacturing material and bonding (e.g., sintering) the additive manufacturing material to a previously constructed layer. The energy source may be configured to melt the additive manufacturing material as the additive manufacturing material is being deposited or melt the additive manufacturing material of an entire layer after the layer of additive manufacturing material has been deposited.

The cure device is a heating device or system for curing the part after material deposition is complete. To that end, the cure device may be an oven, a furnace, a heating element, or any other suitable heating device.

In use, the build platform supports the part as it is being constructed. The material deposition device deposits the additive manufacturing material (and the additive) onto the build platform and onto previously constructed layers. The energy source bonds the additive manufacturing material together. The cure device cures the additive manufacturing material so as to create a part having an improved characteristic via the additive.

Another embodiment of the invention is a method of additive manufacturing a part using fluorine-containing polymers and an additive. First, additive manufacturing material is positioned in an additive manufacturing material reserve and an additive is positioned in an additive reserve of an additive manufacturing system. The additive manufacturing material includes fluorine-containing polymers. The additive may include stainless steel, bronze, molybdenum disulfide, polyimide, or any other suitable additive.

The additive manufacturing material and additive are then mixed and fed to a material deposition device. The additive manufacturing material mixture may be metered in discrete amounts or continuously, depending on movement and position of the material deposition device.

The material deposition device then deposits the additive manufacturing material mixture onto a build platform and previously constructed layers. The specific location and placement of the additive manufacturing material mixture may be according to computer-aided design (CAD) data, or other technical model or drawing, as followed manually by a user or as directed in an automated or semi-automated fashion via control signals provided from a processor.

The additive manufacturing material is then cured in a cure device or sintered via an energy source. For example, the cure device may heat the part so as to cross-link at least some of the deposited additive manufacturing material. This may be done selectively so that certain portions of the deposited additive manufacturing material are cross-linked. Alternatively, the energy source may melt or sinter, and thereby cross-link, selected portions of the additive manufacturing material of the current layer. This may include tracing the energy source over or through the current layer according to CAD data, models, drawings, or other technical resources. A drying system may then be used to dry (or post cure) the part.

Any of the above steps may be repeated multiple times as needed. For example, once one layer of the part has been deposited, another layer of additive manufacturing material may be deposited on the previously deposited layer.

The above-described steps may be performed in any order, including simultaneously. In addition, some of the steps may be repeated, duplicated, and/or omitted without departing from the scope of the present invention.

The above-described additive manufacturing system and method provide several advantages. For example, at least one characteristic of the resulting part is improved depending on the particular additive or additives being used. The additive may be at least one of stainless steel, bronze, molybdenum disulfide, and polyimide. Stainless steel increases strength, rigidity, and wear resistance to fluorine-containing polymer parts. Stainless steel also prevents plastic sag. This has a wide range of applications including high wear and high pressure seals, particularly for aircraft. Bronze increases dimensional stability and lowers creep, cold flow, and wear. This is particularly useful in industries that need improved wear resistance. Molybdenum disulfide increases compression and wear resistance and decreases surface friction (i.e., increases slipperiness). Applications for molybdenum disulfide as an additive in fluorine-containing polymer parts include dynamic seals. Molybdenum disulfide also allows for taking advantage of high temperature properties of fluorine-containing polymers. Adding polyimide reduces friction. Polyimide is non-abrasive, making it a good choice for applications involving softer mating surfaces such as those made of steel, aluminum, or plastics. Adding polyimide is particularly useful for dry running and stop-start applications. The additive(s) may be organic or inorganic.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an additive manufacturing system constructed in accordance with an embodiment of the invention;

FIG. 2 is a schematic diagram of components of the additive manufacturing system of FIG. 1;

FIG. 3 is an enlarged view of an additive manufacturing material mixture including an additive in accordance with an embodiment of the invention; and

FIG. 4 is a flow diagram showing some steps of a method of forming a part via additive manufacturing in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

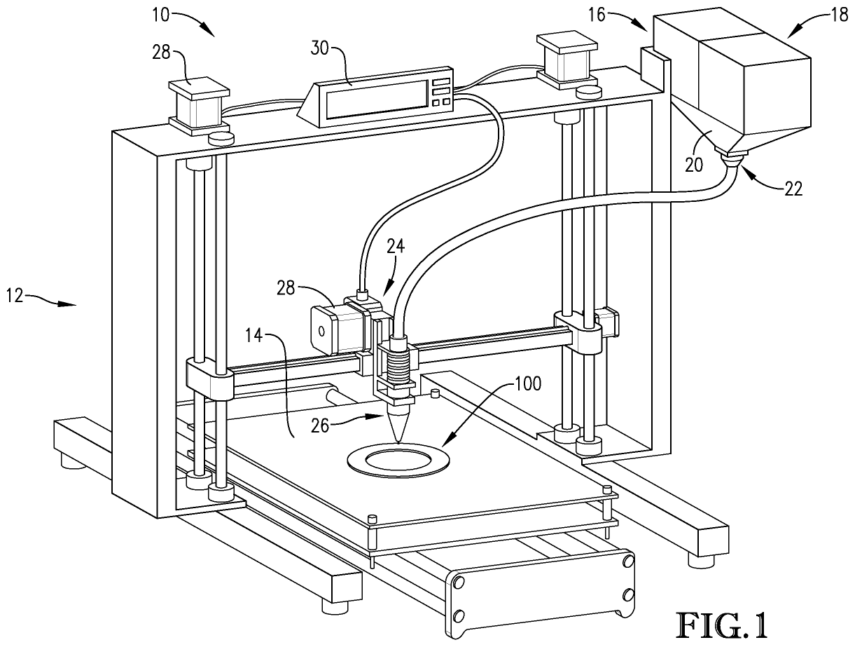

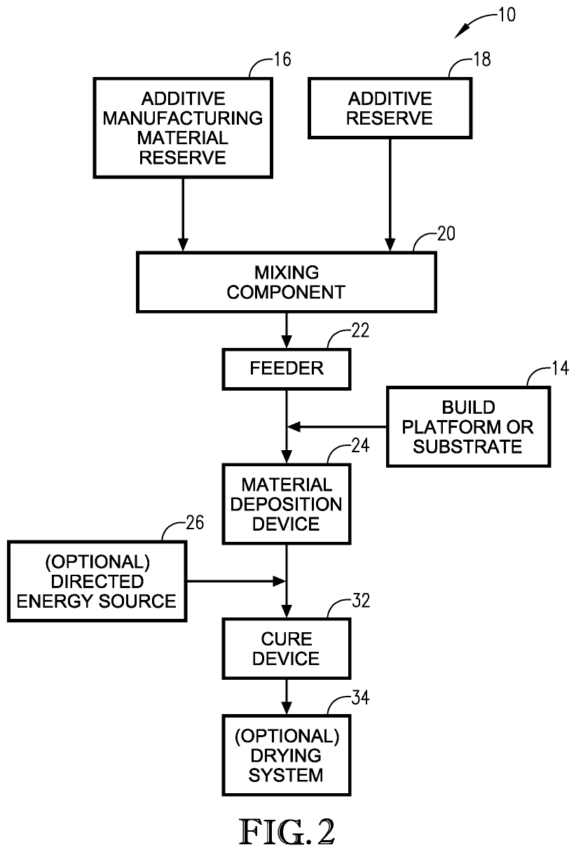

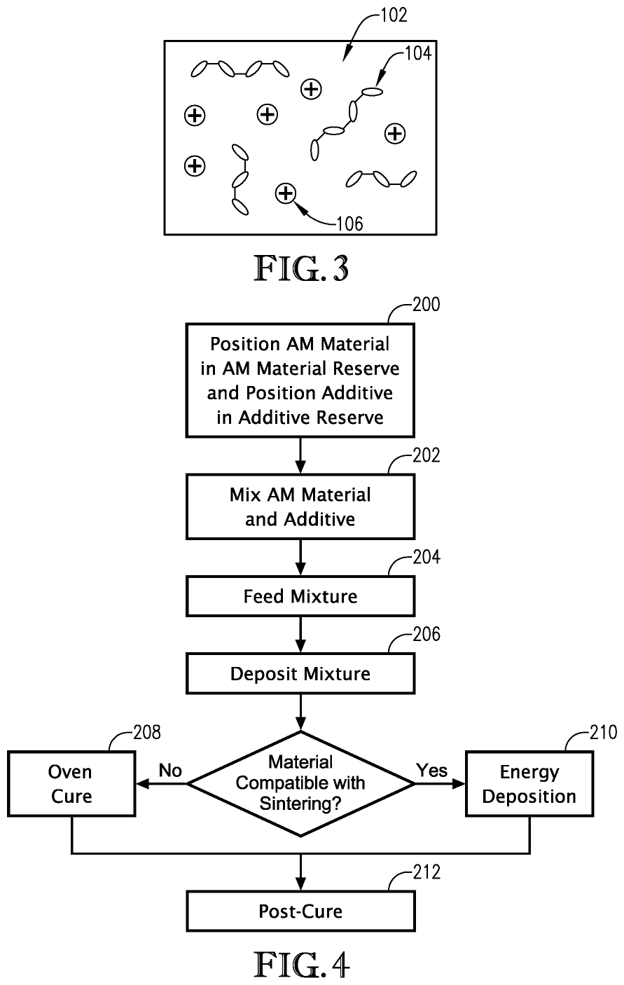

Turning to the drawing figures, and particularly FIGS. 1-3, an additive manufacturing system 10 constructed in accordance with an embodiment of the present invention is illustrated. The additive manufacturing system 10 broadly comprises a frame 12, a build platform 14, an additive manufacturing material reserve 16, an additive reserve 18, a mixing component 20, a feeder 22, a material deposition device 24, an optional energy source 26, a set of motors 28, a processor 30, a cure device 32, and an optional drying system 34.

The frame 12 provides structure for at least the build platform 14, feeder 24, material mixture deposition device 26, energy source 28, and motors 30 and may include a base, vertical members, cross members, and mounting points for mounting the above components thereto. Alternatively, the frame 12 may be a walled housing or similar structure.

The build platform 14 supports a part 100 as it is constructed and may be a stationary or movable flat tray or bed, a substrate, a print plate, a shaped mandrel, a wheel, scaffolding, or similar support. The build platform 14 may be integral with the additive manufacturing system 10 or may be removable and transferable with the part 100 as the part 100 is being constructed.

The additive manufacturing material reserve 16 retains additive manufacturing material 102 and may be a hopper, tank, cartridge, container, spool, or other similar material holder. The additive manufacturing material reserve 16 may be integral with the additive manufacturing system 10 or may be disposable and/or reusable.

The additive manufacturing material 102 includes fluorine-containing polymers 104. The fluorine-containing polymers 104 may be polytetrafluoroethylene (PTFE), fluorinated ethylene propylene (FEP), perfluoroalkoxy (PFA), ethylene tetrafluoroethylene (ETFE), or any other suitable fluorine-containing polymer.

The additive material reserve 18 retains the additive 106 and may be a hopper, tank, cartridge, container, spool, or other similar material holder. The additive material reserve 18 may be integral with the additive manufacturing system 10 or may be disposable and/or reusable.

The additive 106 may be at least one of stainless steel, bronze, molybdenum disulfide, and polyimide. Stainless steel increases strength, rigidity, and wear resistance to fluorine-containing polymer parts made via additive manufacturing. Stainless steel also prevents plastic sag. This has a wide range of applications including high wear and high pressure seals, particularly for aircraft. Bronze increases dimensional stability and lowers creep, cold flow, and wear, which is particularly useful in industries that need improved wear resistance. Molybdenum disulfide increases compression and wear resistance and decreases surface friction (i.e., increases slipperiness). Applications for molybdenum disulfide as an additive in fluorine-containing polymer parts include dynamic seals. Molybdenum disulfide also allows for taking advantage of high temperature properties of fluorine-containing polymers. Polyimide herein refers to a class of synthetic polymers. Adding polyimide reduces friction. Polyimide is non-abrasive, making it a good choice for applications involving softer mating surfaces such as those made of steel, aluminum, or plastics. Adding polyimide is particularly useful for dry running and stop-start applications. The additive(s) may be organic or inorganic.

An additional material such as calcium fluoride or glass may further be added to the additive manufacturing material mixture. The additional material may be organic or inorganic. The additional material may account for up to 25% in one embodiment, up to 40% in another embodiment, or up to 55% in yet another embodiment of the additive manufacturing material mixture.

The mixing component 20 is connected downstream of the additive manufacturing material reserve 16 and the additive material reserve 18 and upstream of the feeder 22. The mixing component 20 combines, via continuous inline mixing, batch mixing, or the like, the additive 106 with the fluorine-containing polymers 104 to form a homogenous mixture. The mixing component 20 may be a mechanical mixer, a planetary mixer, a resonance acoustic mixer, or any other suitable mixer.

The feeder 22 is connected downstream of the mixing component 20 and directs the additive manufacturing material 102 (now as a mixture) to the material deposition device 24. The feeder 22 may be a pump, an auger, or any other suitable feeder. Alternatively, the additive manufacturing material 102 may be gravity fed to the material deposition device 24.

The material deposition device 24 may include a nozzle, guide, sprayer, rake, or other similar component for depositing the additive manufacturing material mixture onto the build platform 14 and previously constructed layers via DIW or a similar technique. In one embodiment, the material deposition device 24 deposits additive manufacturing material 102 to create a lattice structure.

The optional energy source 26 may be a laser, heater, or similar component for melting the additive manufacturing material 102 and bonding (e.g., sintering) the additive manufacturing material 102 to a previously constructed layer. The energy source 26 may be configured to melt the additive manufacturing material 102 as the additive manufacturing material 102 is being deposited or melt the additive manufacturing material 102 of an entire layer after the layer of additive manufacturing material 102 has been deposited. The energy source 26 may be a directed energy source configured to selectively melt portions of the additive manufacturing material 102.

The motors 28 position the material deposition device 24 over the build platform 14 and previously constructed layers and move the material deposition device 24 as the additive manufacturing material 102 is deposited onto the build platform 14 and the previously constructed layers. The motors 28 may be oriented orthogonally to each other so that a first one of the motors 28 is configured to move the material deposition device 24 in a lateral “x” direction, a second one of the motors 28 is configured to move the material deposition device 24 in a longitudinal “y” direction, and a third one of the motors 28 is configured to move the material deposition device 24 in an altitudinal “z” direction. Alternatively, the motors 28 may move the build platform 14 (and hence the part 100) while the material deposition device 24 remains stationary.

The processor 30 directs the material deposition device 24 via the motors 28 and activates the material deposition device 24 such that the material deposition device 24 deposits the additive manufacturing material 102 onto the build platform 14 and previously constructed layers according to a computer aided design of the part. The processor 30 may include a circuit board, memory, display, inputs, and/or other electronic components such as a transceiver or external connection for communicating with other external computers.

The processor 30 may implement aspects of the present invention with one or more computer programs stored in or on computer-readable medium residing on or accessible by the processor. Each computer program preferably comprises an ordered listing of executable instructions for implementing logical functions in the processor 30. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The cure device 32 may be a heating device or system for curing the part 100 after deposition is complete. The cure device 32 may be an oven, a furnace, a heating element, or any other suitable heating device. The cure device 32 heats the part 100 so as to crosslink polymers in the additive manufacturing material 102.

The optional drying system 34 may use heat, positive airflow, humidity control, or a combination thereof to dry the part 100. Alternatively, the part 100 may be air-dried.

The additive manufacturing system 10 may be any type of additive manufacturing or “3D printing” system such as a sintering, laser melting, laser sintering, DIW, extrusion, fused filament, stereolithography, light polymerizing, powder bed, wire additive, or laminated object manufacturing system. The additive manufacturing system 10 may also be a hybrid system that combines additive manufacturing with molding, scaffolding, and/or other subtractive manufacturing or assembly techniques.

Turning to FIG. 4, and with reference to FIGS. 1-3, use of the additive manufacturing system 10 will now be described in more detail. First, the additive manufacturing material 102 may be positioned in the additive manufacturing material reserve and the additive 106 may be positioned in the additive material reserve 18, as shown in block 200.

The additive manufacturing material 102 (including the fluorine-containing polymers 104) and the additive 106 may then be mixed together via the mixing component 20 to create a homogenous additive manufacturing material mixture, as shown in block 202. The additive 106 improves at least one characteristic of the part, depending on the additive as discussed above. The mixing component 20 may selectively add the additive 106 to the additive manufacturing material 102 according to computer-aided design (CAD) data, or other technical model or drawing, as followed manually by a user or as directed in an automated or semi-automated fashion via control signals provided from the processor 30 to the motors 28.

The additive manufacturing material mixture may then be fed to the material deposition device 24 via the feeder 22, as shown in block 204. The additive manufacturing material mixture may be metered in discrete amounts or continuously, depending on movement and position of the material deposition device 24.

The material deposition device 24 may then deposit the additive manufacturing material mixture onto the build platform 14 and previously constructed layers, as shown in block 206. The specific location and placement of the additive manufacturing material mixture may be according to computer-aided design (CAD) data, or other technical model or drawing, as followed manually by a user or as directed in an automated or semi-automated fashion via control signals provided from the processor 30 to the motors 28. In one embodiment, the additive manufacturing material mixture may be deposited to form a lattice structure.

The additive manufacturing material 102 and additive 106 may be mixed together, metered, and deposited so that the additive (and hence an improved part characteristic) is distributed evenly throughout the resulting part. Alternatively, the additive manufacturing material 102 and additive 106 may be at least one of mixed together, metered, and deposited such that the additive (and hence an improved part characteristic) is selectively distributed with a gradient or change within the resulting part.

In one embodiment, if the additive manufacturing material 102 is incompatible with sintering, the additive manufacturing material 102 may be cured in the cured device 32, as shown in block 208. To that end, the cure device 32, may heat the part 100 so as to cross-link at least some of the deposited additive manufacturing material 102. This may be done selectively so that certain portions of the deposited additive manufacturing material 102 are cross-linked. Alternatively, the additive manufacturing material 102 may be allowed to passively cure (e.g., at room temperature). However, doing so may consume more time. In another embodiment, the additive manufacturing material 102 may be heat cured during processing.

In another embodiment, if the additive manufacturing material 102 is compatible with sintering, the optional energy source 26 may melt or sinter, and thereby cross-link, selected portions of the additive manufacturing material 102 of the current layer, as shown in block 210. This may include tracing the energy source 26 over or through the current layer according to CAD data, models, drawings, or other technical resources. The additive manufacturing material 102 may fuse together and to additive manufacturing material of a previously layer. Temperature ranges for this step are selected to prevent deterioration of the additive manufacturing material 102.

Note that any of steps 200-210 may be repeated multiple times as needed. For example, once one layer of the part has been deposited, another layer of additive manufacturing material may be deposited on the previously-deposited layer. This may be accomplished through first lowering the build platform 14 relative to the material deposition device 24 and energy source 26.

The optional drying system 34 may then dry (or post cure) the part, as shown in block 212. To that end, the part may be dried via heat, positive airflow, humidity control, or a combination thereof. Alternatively, the part may be air-dried.

The above-described steps may be performed in any order, including simultaneously. In addition, some of the steps may be repeated, duplicated, and/or omitted without departing from the scope of the present invention.

The above-described additive manufacturing system 10 and method provide several advantages. Specifically, at least one characteristic of the resulting part is improved depending on the particular additive or additives. The additive 106 may be at least one of stainless steel, bronze, molybdenum disulfide, and polyimide. Stainless steel increases strength, rigidity, and wear resistance to fluorine-containing polymer parts made via additive manufacturing. Stainless steel also prevents plastic sag. This has a wide range of applications including high wear and high pressure seals, particularly for aircraft. Bronze increases dimensional stability and lowers creep, cold flow, and wear, which is particularly useful in industries that need improved wear resistance. Molybdenum disulfide increases compression and wear resistance and decreases surface friction (i.e., increases slipperiness). Applications for molybdenum disulfide as an additive include dynamic seals. Molybdenum disulfide also allows for taking advantage of high temperature properties of fluorine-containing polymers. Adding polyimide reduces friction. Polyimide is non-abrasive, making it a good choice for applications involving softer mating surfaces such as those made of steel, aluminum, or plastics. Adding polyimide is particularly useful for dry running and stop-start applications. The additive(s) may be organic or inorganic.

An additional material such as calcium fluoride or glass may further be added to the additive manufacturing material mixture. The additional material may be organic or inorganic. The additional material may account for up to 25% in one embodiment, up to 40% in another embodiment, or up to 55% in yet another embodiment of the additive manufacturing material mixture.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of forming a part via additive manufacturing, the method comprising steps of:
mixing an additive with fluorine-containing-polymers so as to form an additive manufacturing material mixture for improving a characteristic of the part;
depositing the additive manufacturing material mixture onto a build platform; and
curing the additive manufacturing material mixture so that the part has the improved characteristic.

2. The method of claim 1, further comprising steps of delivering the fluorine-containing-polymers from an additive manufacturing material reserve and delivering the additive from an additive reserve.

3. The method of claim 2, wherein the fluorine-containing-polymers and the additive are delivered to a mixer downstream of the additive manufacturing material reserve and the additive reserve.

4. The method of claim 3, the mixing step including selectively adding the additive to the fluorine-containing-polymers via the mixer.

5. The method of claim 1, wherein the additive is stainless steel for increasing strength and rigidity of the part.

6. The method of claim 1, wherein the additive is bronze for increasing dimensional stability.

7. The method of claim 1, wherein the additive is molybdenum disulfide for increasing compression and wear resistance.

8. The method of claim 1, wherein the additive is a polyimide for reducing friction of the part.

9. The method of claim 1, further comprising a step of selectively cross-linking portions of the additive manufacturing material mixture via a directed energy source.

10. The method of claim 1, wherein the characteristic is improved evenly throughout the part.

11. A method of forming a part via additive manufacturing, the method comprising steps of:
selectively mixing an additive with fluorine-containing-polymers so as to form an additive manufacturing material mixture for improving a characteristic of the part;
depositing the additive manufacturing material mixture onto a build platform;
selectively cross-linking portions of the additive manufacturing material mixture deposited on the build platform via a directed energy source; and
curing the cross-linked portions of the additive manufacturing material mixture so that the part has the improved characteristic.

12. The method of claim 11, further comprising steps of delivering the fluorine-containing-polymers from an additive manufacturing material reserve and delivering the additive from an additive reserve.

13. The method of claim 12, wherein the fluorine-containing-polymers and the additive are delivered to a mixer downstream of the additive manufacturing material reserve and the additive reserve.

14. The method of claim 13, the mixing step including selectively adding the additive to the fluorine-containing-polymers via the mixer.

15. The method of claim 11, wherein the additive is stainless steel for increasing strength and rigidity of the part.

16. The method of claim 11, wherein the additive is bronze for increasing dimensional stability.

17. The method of claim 11, wherein the additive is molybdenum disulfide for increasing compression and wear resistance.

18. The method of claim 11, wherein the additive is a polyimide for reducing friction of the part.

19. The method of claim 11, wherein the selectively cross-linking step includes directing an energy source at the portions of the deposited additive manufacturing material mixture according to a computer-aided design.

20. A method of forming a part via additive manufacturing, the method comprising steps of:
delivering fluorine-containing-polymers from an additive manufacturing material reserve to a mixer downstream of the additive manufacturing material reserve;
delivering an additive from an additive reserve to the mixer, the additive being at least one of stainless steel, bronze, molybdenum disulfide, and a polyimide;
selectively mixing the additive with the fluorine-containing-polymers via the mixer according to a computer-aided design so as to form an additive manufacturing material mixture for improving a characteristic of the part;
depositing the additive manufacturing material mixture onto a build platform;
selectively cross-linking portions of the additive manufacturing material mixture deposited on the build platform according to a computer-aided design via a directed energy source; and
curing the cross-linked portions of the additive manufacturing material mixture so that the part has the improved characteristic.
